(19) United States
(12) Patent Application Publication
(10) Pub. No.: US 2016/0193771 A1
(43) Pub. Date: Jul. 7, 2016

(54) METHOD FOR PRODUCING SUPERFICIALLY CRYSTALLINE SPHERICAL GRANULES BY MEANS OF AIR-COOLED HOT DIE FACE PELLETIZING AND APPARATUS FOR CARRYING OUT THE METHOD

(71) Applicant: MAAG AUTOMATIK GMBH, Grossostheim (DE)

(72) Inventors: Stefan Deiss, Harxheim (DE); Reinhardt-Karsten Murb, Aschaffenburg (DE)

(21) Appl. No.: 15/068,285

(22) Filed: Mar. 11, 2016

Related U.S. Application Data
(63) Continuation of application No. PCT/EP2014/002450, filed on Sep. 10, 2014.

(30) Foreign Application Priority Data
Sep. 11, 2013 (DE) 102013015190.2

(51) Int. Cl. B29C 47/00; B29C 47/08; B29B 13/02; B29C 47/88; B29C 47/30; B29C 47/86

(52) U.S. Cl. CPC B29C 47/0066; B29C 47/0011; B29C 47/30; B29C 47/862; B29B 13/022; B29C 47/8815; B29C 47/0898; B29K 2067/003

(57) ABSTRACT

A method and a device for producing superficially crystalline spherical granules by means of air-cooled hot die face pelletizing in a cutting chamber. A crystallizable plastic material can be melted and then extruded through a perforated plate. During the air-cooled hot die face pelletizing, at least one cutting blade can be moved relative to the perforated plate. The perforated plate can be temperature-controlled while maintaining a viscosity of the plastic material within nozzle openings. A superficial cooling to a crystal nucleation temperature of the dry-cut granules is performed by means of a centripetally inflowing process gas. The crystal nucleation temperature is below an optimum crystal growth temperature and above a glass transition temperature. By controlling the quantity of process gas at an adiabatic temperature, an average granule temperature is maintained in a range of an optimum crystal growth temperature.

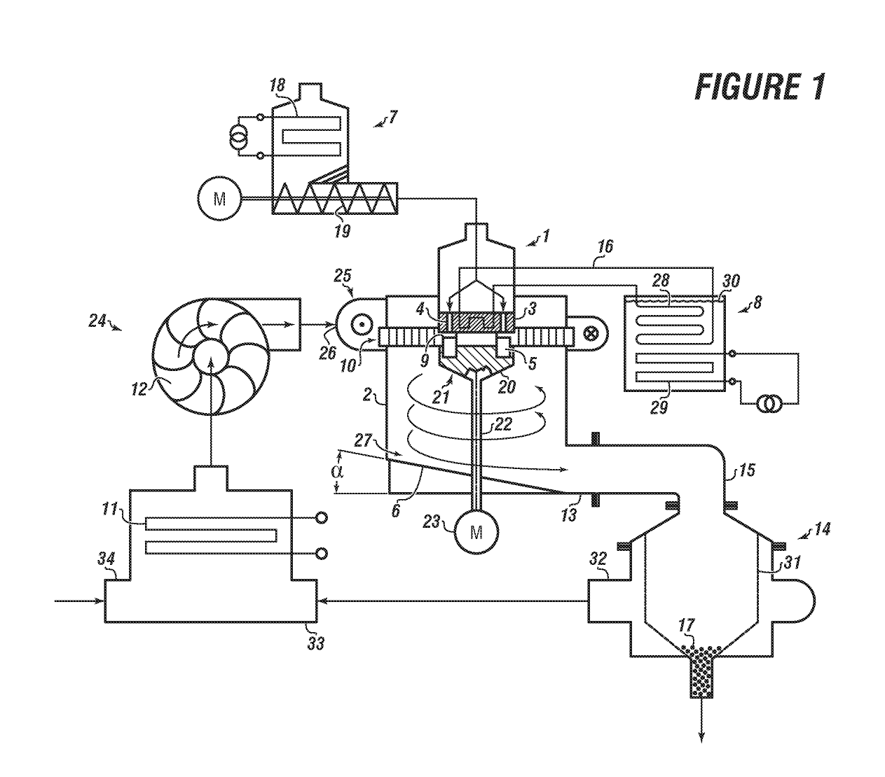

### CROSS REFERENCE TO RELATED APPLICATIONS

The present patent application is a Continuation that claims priority to and the benefit of co-pending International Patent Application No. PCT/EP2014/002450 filed Sep. 10, 2014, entitled “METHOD FOR PRODUCING SUPERFICIALLY CRYSTALLINE SPHERICAL GRANULES BY MEANS OF AIR-COOLED HOT DIE FACE PELLETIZING AND APPARATUS FOR CARRYING OUT THE METHOD”, which claims priority to DE Application No. 102013015190.2 filed Sep. 11, 2013. These references are hereby incorporated in their entirety.

### FIELD

The present embodiments generally relate to a method for producing superficially crystalline spherical granules by means of air-cooled hot die face pelletizing, and an apparatus for carrying out the method.

### BACKGROUND

Melt material today is generally worked and processed by granulation. In general extruders or melt pumps are oftentimes used to granulate melt material, such as plastics. These extruders or melt pumps press molten plastic base material through nozzles in a perforated plate into a cooling medium, such as water.

Material emerging from the openings in the nozzles are cut at this point by a cutting blade assembly which has at least one rotating cutting blade, so that pellets are produced. Corresponding devices that carry out underwater granulation processes are known as underwater granulation systems, such as SPHERO® manufactured by Automatik Plastics Machinery GmbH.

Prior art has disclosed an apparatus for granulating plastic in a cooling and feed air flow according to a so-called air-cooled hot die face pelletizing method, which may be used, for example, for PVC material. However, it does not address the crystallization of plastic.

Prior art has also disclosed a method and an apparatus for granulating thermoplastic material, a flow-optimized radial inflow of a cooling liquid being provided to thereby reduce the amount of energy required to drive the cutting blade in the liquid coolant. This invention also does not address special approaches to the problems of manufacturing crystallizable products of a corresponding de-sign.

In manufacturing crystallizable products from a melt material, the uniform size and weight as well as the uniformly achievable shape of the products are essential considerations. Large volumes are also desirable, which makes it necessary for a corresponding production method to proceed reliably with a very large number of pellets (such as, up to 500 million units per hour).

Systems for carrying out air-cooled hot die face pelletizing in air as the cooling medium have already been on the market for a very long time, since they represent comparatively easy-to-build machines for granulating strand-extruded thermoplastics.

Melt strands emerging from a perforated plate are chopped into small pieces forming pellets with the aid of cutting blades, which rotate as closely as possible to the surface, and by the inertia intrinsic to the strand material. Due to the rotation of the cutting blade, air which carries the pellets more or less freely and centrifugally away from the cutting location is drawn in from the surroundings or the interior of the cutting chamber by means of fan blades rotating together with the cutting blades.

The problems that occur lie in poor cooling of the cutting blades, which may overheat and get stuck over time, as well as the tendency of such systems to get stuck and clogged due to the centrifugal accelerations of the rotation of the cutting blades acting upon the granules, in particular in the case of high flow rates with large volumes of pellets to be manufactured under real production conditions.

Pellets manufactured in this way furthermore tend toward cylindrical and irregular shapes, especially if the viscosity of the melt material is relatively high, a great many spherical pellets of a uniform size in the millimeter diameter range being required in the subsequent applications, particularly in the case of crystallizable materials. Microgranules of this type typically have a pellet size with a diameter less than or equal to 1.5 mm.

The object of the present invention is to provide a method for producing crystallizable products from a melt material, which overcomes the disadvantages of the prior art and which, in particular, relatively easily and cost-effectively facilitates an effective granulation of pellets of crystallizable products having the same pellet size and a uniform as well as unchanging shape even when large volumes of pellets are to be produced under real production conditions.

Another object of the invention is to provide an apparatus for carrying out the method for producing superficially crystalline spherical granules by means of air-cooled hot die face pelletizing. In particular, the object of the present invention is to facilitate this in connection with the applications for manufacturing microgranules having a pellet size of less than or equal to 1.5 mm in diameter.

The present embodiments meet these objects.

### BRIEF DESCRIPTION OF THE DRAWINGS

The detailed description will be better understood in conjunction with the accompanying drawing as follows:

The Figure shows a schematic sectional view of an air-cooled hot die face pelletizing apparatus for carrying out the method according to the invention.

The present embodiments are detailed below with reference to the Figure.

### DETAILED DESCRIPTION OF THE EMBODIMENTS

Before explaining the present apparatus in detail, it is to be understood that the apparatus is not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

A first aspect of the invention relates to a method, by means of which superficially crystalline spherical granules are produced in a cutting chamber by means of air-cooled hot die face pelletizing.

For this purpose, a crystallizable plastic material is first melted. The crystallizable plastic material can be then extruded through a perforated plate. During the air-cooled hot die face pelletizing of granules with the aid of at least one cutting blade which is moved relative to the perforated plate, the perforated plate can be temperature-controlled while maintaining a viscosity of the melt of the plastic material within the openings of the perforated plate.

A superficial cooling of the dry-cut granules can be performed by means of a centripetally inflowing process gas for cooling to a superficial crystal nucleation temperature, the crystal nucleation temperature can be below an optimum crystal growth temperature and above a glass transition temperature of the crystallizable plastic material.

Afterwards, by controlling the quantity of process gas at an adiabatically set temperature, an average granule temperature can be maintained in a range of an optimum crystal growth temperature at a level above the crystal nucleation temperature and below a melting temperature of the plastic material. As the granules flow in the cutting chamber without touching the walls, the process gas flow can continue to be conducted until the granules have a crystalline layer growing away from their surface.

This method has the advantage that crystal nucleation on the surface of the cut pellets is initially intensified by the centripetal cooling gas conductance and the initially low cooling temperature of the inflowing process gases.

The inflowing process gasses can cool the pellets superficially to a temperature which is still below an optimum crystal growth temperature, thereby ensuring that the pellets do not touch an inner wall of the cutting chamber in the initial nucleation phase and the subsequent nucleus growth phase and are unable to adhere to the inner wall, since they are conducted in the centripetal process gas flow.

During this first cooling (or quench) phase for superficial crystal nucleation, the process gas can draw heat away from the pellets and can be thus heated itself, which promotes the further crystal growth of the crystal nuclei, since the optimum crystal growth temperature is above the crystal nucleation temperature but below the melting temperature of crystallizable thermoplastics.

The crystal growth is also promoted by latent heat stored inside the pellets, since this latent, i.e. internal, heat of the cut pellets does is not dissipated as quickly during air-cooled hot die face pelletizing as during liquid cooled pelletizing.

During air-cooled hot die face pelletizing, a polycondensation process and the crystallization process are not limited or even prevented by such a high heat dissipation as when the surface of the pellets come into contact with a cooling liquid such as water, since the heat conductance of process gases is much lower than the heat dissipating power of cooling liquids. The heat transfer or the heat transfer coefficient due to convection is thus approximately ten times higher or greater in a cooling liquid such as water than in a gas such as air.

As a result, much longer polycondensation chains can form in the volume of the granules, and thus a higher quality product may be produced with the use of air-cooling hot die face pelletizing for crystallizable plastic materials. Another advantage of the method is that, until the formation of a non-adhering, crystalline near-surface layer of the granules, a contact with the wall thereof is prevented by the process gas guidance.

The gaseous cooling medium needed for cooling and removing the freshly cut pellets, particularly with regard to the usually present moisture sensitivity of a thermoplastic to be crystallized, can be supplied to the cutting area in the cutting chamber in such a way that it offers as little resistance as possible to the at least one blade of the cutting blade assembly and simultaneously removes the pellets from the crystallizable melt material as quickly as possible from the rotation area of the at least one blade and thus, from the cutting area.

A high specific throughput of material (large volumes of relatively small pellets in the millimeter diameter range) is thus possible, a clumping together of the pellets being simultaneously avoidable due to the good dry cooling according to the invention and the uniform flow behavior of the process gas flow, including the pellets from the melt material contained therein.

In another embodiment of the invention, the formation of a non-stick crystalline surface layer of the pellets can be completed when the pellets reach the outlet of the cutting chamber in the process gas flow and roll away on a roller plate. The rolling of the non-stick, crystalline outer shell or surface layer of the granules advantageously supports a formation, shaping and homogenization of the high quality spherical shape of the granules.

After passing the rotation area, the pellets contained in the process gas can flow on to the area of the outlet of the housing, in which they can be guided at an angle of less than 15 degrees against a wall of the housing located there, so that a rolling movement is imparted to the pellets contained in the process gas flow. The rolling movement reliably achieves the uniform shaping of the pellets.

A ratio between the mass flow of the process gas and the mass flow of the pellets contained therein in the cutting chamber can constitute a charge ratio, defined as the mass of the pellets per hour to the mass of the process gas per hour, in the range of 0.3 to 0.7, such as a charge ratio of 0.5. It is thus also possible to reliably prevent pellets from sticking together, particularly with high throughput rates, since sufficient process gas can be present to surround the pellets individually without allowing clumping to cool and transport them.

In one exemplary embodiment of the method, a polymerizable and/or polycondensable thermoplastic can be used as the crystallizable plastic material. Thermoplastics of this type become a tough, viscous adhesive material above their softening temperature so that, when a melt of a thermoplastic is cooled to a level above a softening temperature, a sticky surface is formed, which is avoidable only by quickly dropping below the softening temperature, which is also known as the glass transition temperature because the melt transitions from a liquid, molten state to a solid, amorphous state at this temperature.

However, if this plastic is maintained above its glass transition temperature for a period of time, crystallization nuclei can form from the surface, and a crystal growth may be initiated. With the aid of the crystal growth, it is possible to cause a crystalline layer to form on the surface, for example of a granule, and for this thermoplastic granule to thus lose its sticky properties even above the glass transition temperature, due to the crystalline shell near the surface.

For this purpose, in embodiments, melts of the crystalline thermoplastics can be first fragmented or cut into pellets with the aid of the cutting blade and then briefly cooled to a temperature above the glass transition temperature and to a temperature below a much higher, optimum crystal growth temperature, so that a preferably rapid crystal nucleation sets in.

The first cooling phase or crystal nucleation phase consequently requires a rapid cooling immediately after cutting pellets, in particular if a polycondensable poly-ethanediol terephthalate material (“PET”) is used as the crystallizable plastic material.

In another embodiment of the method, the temperature control of the perforated plate is maintained in a temperature range from 250 degrees Celsius to 330 degrees Celsius, with a tolerance of ±0.5 to ±1 K, with the aid of a thermal fluid circuit. This narrow tolerance range is intended to prevent the crystallizable plastic melt within nozzle openings of the perforated plate from clogging these openings and prematurely ending or interrupting the process.

A heat transfer oil, which can be maintained within the aforementioned temperature range from 250 degrees Celsius to 330 degrees Celsius, with a tolerance of ±1 to ±5 K, in a heat control device, can be used as the thermal fluid for the thermal fluid circuit for controlling the temperature of the perforated plate.

In the case of the air-cooled hot die face pelletizing of the granules, cooling by a centripetal process gas flow can take place at a crystal nucleation temperature in a temperature range from 100 degrees Celsius to 120 degrees Celsius for cut PET granules for the purpose of forming crystallization nuclei from the surface. This temperature for crystal nucleation is dependent on the material of the thermoplastic.

In another embodiment of the invention, the temperature of the cut PET granules in the cutting chamber can be subsequently maintained by a centripetal process gas flow at a crystal growth temperature in a temperature range from 150 degrees Celsius to 200 degrees Celsius for the purpose of forming a crystalline layer from the surface of the cut PET granules.

Optimum crystal growth temperature can be much higher than the crystallization temperature, which is above the glass transition temperature but below the range for an optimum crystal growth, so that, on the one hand, the additional heat required promotes the crystal growth by means of the stored inner heat of each individual pellet and, on the other hand, the relatively cool process gas heats up during the cutting of the granules due to the absorption of the heat of fusion of the granules, thus additionally supporting the crystal growth.

However, since the heat dissipation through the process gas is much slower than the heat absorption, for example by a cooling water, the crystal growth phase and also the polymerization and polycondensation phases for the plastic are greatly prolonged by the air-cooled hot die face pelletization process, so that a high quality product is achievable using the method according to the invention.

With regard to PET plastics, the inner heat stored in the granules may facilitate a formation of long-chain molecules from polycondensates in the dry process gas flow.

In embodiments, the granules having a crystalline surface layer are guided by the process gas flow in the cutting chamber onto a roller plate, which projects into the process gas flow at an acute angle from 5 degrees to 15 degrees or forms the end of the crystallization phase for the granules at the outlet of the cutting chamber.

Another aspect of the invention relates to an apparatus for producing superficially crystalline spherical granules by means of air-cooled hot die face pelletizing in a cutting chamber.

The apparatus includes an extrusion system with a perforated plate, which projects into the cutting chamber for the purpose of forming temperature-controlled plastic strands. A temperature control device of the perforated plate can be connected to a thermal fluid circuit or includes an electrically operated temperature control device.

At least one rotating cutting blade can be arranged within the cutting chamber, and a cutting edge of the cutting blade passes over nozzle openings of the perforated plate for separating plastic strands from the perforated plate. Process gas nozzles can be oriented in such a way that they project into the cutting chamber and form a centripetal process gas flow with respect to the cut granules.

A process gas temperature control and process gas dosing device can regulate the temperature and quantity and, if necessary, the speed of the process gas flowing into the cutting chamber. This can influence the resulting heat transfer coefficient between the pellets and the process gas. The aperture width of nozzle(s), through which the process gas flows into the cutting chamber, can be set accordingly, for example with the aid of an adjusting mechanism.

A roller plate for granules can be arranged at an acute angle in the process gas flow at an outlet of the cutting chamber. A separating and collecting container is connected to the outlet of the cutting chamber via a granule feed line.

This apparatus has the advantage that a circumferentially uniform, i.e. a throughput rate of process gas which is of a consistent or at least essentially consistent size is able to flow into the cutting chamber, due to the correspondingly designed process gas nozzles which can project into the cutting chamber. In embodiments, the nozzles can be oriented in a circumferential nozzle ring assembly having adjustable fan blades.

Air, nitrogen, an inert gas, or a reaction gas can be provided as the process gas, which is selected in such a way that it is able to enter into a desired chemical reaction with the melt material to be granulated. The process gas may be correspondingly introduced via the process gas nozzles into the rotation area of the cutting chamber, flowing from all sides radially from the outside to the inside at the height of at least one rotating cutting blade.

In embodiments, the temperature control device of the perforated plate can include a thermal fluid circuit, which maintains perforated plate temperature within a temperature range from 250 degrees Celsius to 330 degrees Celsius, with a tolerance of ±1 to ±5 K. As discussed above with regard to the method, the exact maintenance of the temperature of the perforated plate is crucial to avoid clogging the nozzle openings of the perforated plate, which would result in an interruption of the process.

It is furthermore provided that the process gas temperature control and process gas dosing device can regulate the process gas quantity and the temperature in such a way that during the air-cooled hot die face pelletizing of the granules, a crystal nucleation temperature is first maintained within a temperature range from 100 degrees Celsius to 120 degrees Celsius for the purpose of forming crystallization nuclei of PET granules cut from the surface, so that the crystal growth to a near-surface layer of the granules may subsequently take place.

It is furthermore provided that the roller plate can project into the process exhaust gas flow in the outlet area of the cutting chamber at an acute angle from 5 degrees to 15 degrees. The advantage associated with this with regard to the uniformity and spherical design of the shape of the granules has already been noted above.

Due to the process gas nozzles, arranged in embodiments to run circumferentially, the process gas can be supplied from the outside to the inside, i.e. centripetally, or essentially from the outside to the inside of the cutting chamber in the rotation area, i.e. in the area of the plane of intersection.

This process gas nozzle assembly can be fed via a separate process gas chamber arranged around the housing. Due to the correspondingly provided design of the process gas feed line and/or the definition of the dimensions of the process gas nozzle assembly, the process gas may be lent an (additional) circumferential speed when it enters the cutting chamber, which approximately corresponds to the rotational speed of the at least one cutting blade of the cutting blade assembly.

The resulting acceleration of the process gas to the desired speed, i.e. the energy required to achieve the desired angular momentum, can be obtained from the pressure of the process gas. The additional circumferential speed of the process gas, which may be additionally provided above, may be set either mechanically via the design of the process gas nozzle assembly and/or by controlling the throughput rate of the gaseous process gas and adapted to various other process parameters (material throughput, melt material to be granulated, size of the pellets, and the like). The quantity and rotational speed of the cutting blade(s) may also be adapted accordingly.

Since a process gas flow is able to flow in at approximately the same speed as the rotational speed of the at least one cut-ting blade in the rotation area of the cutting chamber, it can flow through the at least one cutting blade or possibly gaps between multiple cutting blades of a cutting blade assembly and carry the freshly cut pellets out of the rotation area, which can reliably prevent the pellets from sticking together even at high throughput rates.

In the resulting flow, the corresponding circumferential speed of the process gas can increase upon approaching the axis of rotation of the at least one cutting blade of the cutting blade assembly, so that the flow movement from the outside to the inside is made increasingly more difficult and is ultimately prevented. The process gas can thus flow into the space downstream from the at least one cutting blade of the cutting blade assembly and flow in a helical flow away from the area of the perforated plate and the rotation area in the cutting chamber.

Therefore, the centripetal or at least essentially centripetal flow of the process gas may be imparted to the process gas flowing to the cutting chamber with the aid of a shape of an outer process gas chamber radially surrounding the cutting chamber and the process gas nozzle assembly projecting into the cutting chamber in the rotation area, and an additional angular momentum may also be imparted thereto, which is oriented accordingly in the direction of rotation of the at least one cutting blade.

The size of the additional angular momentum may preferably be so large that the corresponding speed of the process gas in the direction of the rotation of the cutting blade assembly is as high as the rotational speed of the cutting blade assembly.

Another optimized flow guidance of the process gas, as explained above, can be facilitated in this embodiment of the apparatus according to the invention. The flow of the process gas preferably can run in such a way that is it oriented and flows away perpendicularly to the perforated plate. The resulting pellets are therefore blown away from the perforated plate in a perpendicular to helical manner. The volume flow of the process and transport gas flowing according to the invention is expediently selected in such a way that the pellets are separated immediately after being cut, i.e. in significant excess.

For example, 4 kg per hour of polymer/crystallizable melt material having a density of 1,200 kg/m³ emerges from a perforated plate having 24 holes and a semicircular diameter of approximately 60 mm and is cut into 13,900 pellets per second with a diameter of 0.5 mm by 9 cutting blades at n=3,900 rpm. The pellets can have a distance of approximately 1 cm from each other in each direction.

The mass flow of the gaseous process and transport gas is approximately 8 kg/h and carries 4 kg/h of feedstock, which corresponds to a ratio of 0.5 between the feedstock and the feeding medium (“charge”). This is far less than what is common practice with pneumatic feeding, where a charge ratio of 10 to 20 is customary in the thick stream feeding of 60 and above even in the case of suspension feeding. Conversely, a significant excess of process and transport gas is thus supplied.

If one examines the heat flows which occur, it may be established that, depending on the polymer/crystallizable melt material, an end temperature of the air and pellets contained therein may reach approximately 55 degrees Celsius if warm air of, e.g., 20 degrees Celsius is supplied. For more intensive or even faster cooling, the air volume must therefore be increased or the feed temperature further reduced.

For the present invention, a throughput rate and/or a pressure and/or a direction of the process gas supplied via the process gas device may also be controlled with the aid of a control unit in such a way that a direction of the flow of the process gas into the cutting chamber may be adjusted thereby. For example, a control unit can be provided which is able to control one or multiple moving, paddle-shaped process gas nozzles.

The solidification of the pellets can be additionally supported by cooling the wall of the cutting chamber and by a cooling fluid flowing through this chamber, for example in a double-walled design.

To further optimize the flow in the area of the outlet as well, the outlet can be arranged in the area of the cutting chamber to face away from the process inflow. It is thus possible to achieve a uniform outflow of the process gas, including the pellets contained therein, out of the crystallizable melt material, whereby a possible clumping in the cutting chamber and, in particular, in the area of the outlet is reliably avoided. The pellets can be collected, for example in an outlet coil, and be removed tangentially from the cutting chamber.

The invention is explained below by way of example on the basis of the appended figure.

The Figure shows a schematic sectional view of an air-cooled hot die face pelletizing apparatus for carrying out the method according to the invention.

The Figure shows a schematic sectional view of an air-cooled hot die face pelletizing apparatus 1 for carrying out the method according to the invention.

Air-cooled hot die face pelletizing apparatus 1 illustrated schematically in the Figure includes a perforated plate 3 with hole-shaped nozzle openings 4 provided therein, which projects into a cutting chamber 2 and represents an outlet nozzle plate of an extrusion system 7. Extrusion system 7 includes a reactor or a melt container having a heating device 18, with the aid of which base material of a crystallizable plastic mass is melted and then fed to perforated plate 3 by means of a discharge screw or by means of an extruder 19 for the purpose of forming plastic strands.

The arrangement of nozzle openings 4 is essentially rotationally symmetrical and the remaining design of air-cooled hot die face pelletizing apparatus 1 also has a rotationally symmetrical or essentially rotationally symmetrical construction. According to the representation in the Figure, perforated plate 3 is assigned a cutting blade assembly 20, which includes at least one cutting blade 5, which has a cutting edge 9, which rotatably passes along nozzle openings 4 of perforated plate 3.

The at least one cutting blade 5 is arranged on a cutting blade carrier 21, which is fixed to a cutting blade shaft 22. Cutting blade assembly 20 is driven by a motor 23, so that the at least one cut-ting blade 5 passes over nozzle openings 4 in perforated plate 3 and separates pellets of the crystallizable melt material emerging from nozzle openings 4. The crystallizable melt material may be first melted in a conventional manner in extrusion system 7 and transported to the area of perforated plate 3, for example via extruder 19 or a melt pump, and pressed out of nozzle openings 4.

To maintain continuous operation, it is necessary to keep perforated plate precisely at an operating temperature from 250 degrees Celsius to 330 degrees Celsius with a tolerance from 1 K to 5 K. For this purpose, the electrical temperature control elements may be thermally connected to the perforated plate or, as in the Figure, a temperature control device 8 having a thermal fluid circuit may be provided. A thermal oil circuit can be provided as thermal fluid circuit 16 in the Figure. The oil situated in circuit 16 is guided through a heat exchanger 28, which is immersed in a fluid bath 30 which is temperature-controlled via a heating system 29.

According to the invention, cutting chamber 2, into which perforated plate 3 projects, is filled with a through-flowing process gas, e.g. air, during operation, cutting chamber 2 surrounding at least the one cutting blade 5 and cut-ting blade carrier 21 as well as at least part of cutting blade shaft 22. In the cutting chamber area facing away from perforated plate 3, cutting blade shaft 22 is guided fluid-tight out of cutting chamber 2, and motor 23 is pro-vided to drive the at least one cutting blade 5 to a rotational motion via cutting blade shaft 22.

A process gas device 24 is provided, which includes a process gas temperature control device 11, a process gas dosing device 12 and a separate process gas chamber 25, which circumferentially surrounds cutting chamber 2 in the area of the rotation of the at least one cutting blade 5, and which is equipped with a process gas nozzle assembly 10, which is circumferentially movably situated between process gas chamber 25 and cutting chamber 2, process gas nozzle assembly 10 in the case illustrated in the Figure forming a circumferentially rotating annular orifice nozzle having a circumferentially uniform nozzle width of, e.g., 3 mm. Process gas chamber 25 has a decreasing cross section over its circumference, i.e. circumferentially, from an inlet opening 26 for the temperature-controlled and dosed process gas in process gas chamber 25, starting in the rotation direction of the at least one cutting blade 5.

According to the design illustrated in the Figure, multiple guiding devices are provided, so that a circumferentially uniform throughput rate of process gas flows through process gas nozzle assembly 10. Due to process gas nozzle assembly 10 between process gas chamber 25 and cutting chamber 2, the process gas is introduced into cutting chamber 2 circumferentially from all sides, radially from the outside to the inside or essentially radially from the outside to the inside. A centripetal or at least essentially centripetal flow of the process gas results at least in the rotation area of the at least one cutting blade 5.

Process gas nozzles 10 are arranged in such a way that, a means of enabling the process gas to flow into all areas of cutting chamber 2 is still present in the circumferential direction. The guiding devices are used to guide the flow of the process gas and not to divide the individual areas over the circumference of separate process gas chamber 25. The arrangement of the individual guiding devices may be distributed, for example, evenly over the circumference of process gas chamber 25 or process gas nozzle assembly 10. The individual guiding devices may be fastened in a stationary manner, e.g. by welding corresponding guide vanes to the walls. The guiding device(s) may also be de-signed to be adjustable individually or preferably together, e.g. by a control unit, the angle of attack, for example, being correspondingly adjustable.

According to the representation in the Figure, an outlet 13 is arranged in the area of cutting chamber 2 facing away from the process gas device. Downstream from the rotation area, the process gas, including the pellets contained therein, continue to flow to the area of outlet 13 of cutting chamber 2, in which they are guided by a roller plate 6 at an angle which can be less than 15 degrees against a wall of cutting chamber 2 located therein, so that a rolling motion is imparted here to the pellets from the crystallizable melt material located in the process gas. Ac-cording to the illustration in The Figure, a helical outlet section 27 is pro-vided in the direction of outlet 13, which correspondingly guides the flow of the outflowing process gas, including the pellets contained therein, to outlet 13 and thus also facilitates a pressure buildup in this area of cutting chamber 2 and/or in outlet 13, namely due to the dynamic pressure caused by helical outlet section 27. A corresponding helical outlet section 27 is also structurally possible.

The process gas flow supplies the superficially crystallized and spherically shaped granules in a millimeter diameter range to a capture and collecting container 14 via a granule feed line 15. The granules are captured in a sieve 31 and separated from the process gas flow. The process gas may be supplied to process gas device 24 via a first inlet 33 for returning the process gas to process gas temperature control device 11 in a circulation process, using a dust filter 32, the process gas being cooled to a process gas temperature in process gas temperature control device 11 or heated up if it drops below this temperature. If the recycled process gas is not sufficient for dosing in process gas dosing device 12, fresh process gas, e.g. air, may be supplied to process gas temperature control device 11 of process gas device 24 via a second inlet 34 for supplying fresh gas.

The apparatus illustrated in the Figure is used to carry out the method according to the invention in the application for manufacturing crystallizable products or spherical PET granules 17 from partially crystalline PET pellets.

In the Figure, air-cooled hot die face pelletizing apparatus 1 is illustrated with a horizontally arranged perforated plate 3 and other correspondingly arranged elements. However, the assembly may also be rotated 90 degrees with respect to the arrangement in The Figure, including a vertically arranged perforated plate 3 and be provided with elements of air-cooled hot die face pelletizing device 1, correspondingly arranged, rotated by 90 degrees.

Air-cooled hot die face pelletizing apparatus 1 as well as the correspondingly described method according to the invention may be advantageously used, in particular according to the invention, for manufacturing microgranules having a grain size of less than/equal to 1.5 mm in diameter, since, according to the invention, correspondingly small pellets may be particularly reliably manufactured in this manner, due to the suitable temperature control capability.

Although at least one exemplary embodiment was illustrated in the preceding description, various changes and modifications may be carried out. The afore-mentioned embodiment is only one example and is not provided to limit the scope of validity, the applicability or the configuration of the device and the method in any way. Instead, the preceding description provides those skilled in the art with a plan for implementing at least one exemplary embodiment of the device and the method, it being possible to make numerous changes in the function and construction of the device and the method steps of the method without departing from the extent of protection of the appended claims and their legal equivalents.

While these embodiments have been described with emphasis on the embodiments, it should be understood that within the scope of the appended claims, the embodiments might be practiced other than as specifically described herein.

What is claimed is:

1. A method for manufacturing superficially crystalline spherical granules by means of air-cooled hot die face pelletizing in a cutting chamber comprising:
a) melting a crystallizable plastic material to form a melt of the plastic material and extruding the melt of the plastic material through a perforated plate;
b) controlling the temperature of the perforated plate;
c) maintaining a viscosity of the melt of the plastic material within nozzle openings of the perforated plate during air-cooled hot die face pelletizing of granules, wherein pelletizing occurs with the aid of at least one cutting blade which is moved relative to the perforated plate;
d) superficially cooling the granules by means of a centripetally inflowing process gas at a superficial crystal nucleation temperature which is below an optimum crystal growth temperature and above a glass transition temperature of the crystallizable plastic material;
e) maintaining an average granule temperature in a range of an optimum crystal growth temperature at a level above the crystal nucleation temperature and below a melting temperature of the plastic material by controlling the quantity of process gas at an adiabatically set temperature; and
f) guiding the process gas flow as the granules flow into a cutting chamber, wherein the granules are prevented from touching the walls until the granules have a crystalline layer growing away from their surface.

2. The method of claim 1, wherein the crystallizable plastic material is a polymerizable and/or a polycondensable thermoplastic.

3. The method of claim 1, wherein the crystallizable plastic material is a polycondensable poly-ethanediol terephthalate material.

4. The method of claim 1, wherein the temperature of the perforated plate is maintained in a range from 250 degrees Celsius to 330 degrees Celsius, with a tolerance from ±1 to ±5 K, with the aid of a thermal fluid circuit.

5. The method of claim 4, wherein a heat transfer oil is used as a thermal fluid in the thermal fluid circuit.

6. The method of claim 3, wherein the centripetally inflowing process gas is introduced during air-cooled hot die face pelletizing of granules at a crystal nucleation temperature at a temperature range from 100 degrees Celsius to 120 degrees Celsius for cut poly-ethanediol terephthalate granules for the purpose of forming crystallization nuclei from a surface of the cut poly-ethanediol terephthalate granules.

7. The method of claim 3, wherein the temperature of the cut poly-ethanediol terephthalate granules in the cutting chamber is maintained by the centripetally inflowing process gas at a crystal growth temperature in a temperature range from 150 degrees Celsius to 200 degrees Celsius for the purpose of forming a crystalline layer from the surface of cut poly-ethanediol terephthalate granules.

8. The method of claim 1, wherein granules having a crystalline surface layer are guided by the centripetally inflowing process gas onto a roller plate which projects into the process gas flow at an acute angle from 5 degrees to 15 degrees.

9. The method of claim 3, wherein inner heat stored in granules facilitates a formation of long-chain molecules of polycondensates of the poly-ethanediol terephthalate plastic.

10. An apparatus for manufacturing superficially crystalline spherical granules by means of air-cooled hot die face pelletizing in a cutting chamber comprising:
a) an extrusion system with a perforated plate which projects into a cutting chamber for the purpose of forming temperature-controlled plastic strands;
b) a temperature control device of the perforated plate including a thermal fluid conduit;
c) at least one rotating cutting blade which passes over nozzle openings in the perforated plate;
d) a process gas nozzle assembly which projects into the cutting chamber, oriented to form a centripetal process gas flow with respect to the cut granules;
e) a process gas temperature control and process gas dosing device which regulates the temperature and the quantity of process gas flowing into the cutting chamber;
f) a roller plate which projects into the process gas flow at an acute angle at an outlet of the cutting chamber; and
g) a separating and collecting container which is connected to the outlet of the cutting chamber via a granule feed line.

11. The apparatus of claim 10, wherein the temperature control device of the perforated plate maintains the perforated plate in a temperature range from 250 degrees Celsius to 330 degrees Celsius, with a tolerance of ±1 to ±5 K.

12. The apparatus of claim 10, wherein the process gas temperature control and process gas dosing device regulates the quantity of process gas, temperature and speed in such a way that a crystal nucleation temperature in a temperature range between 100 degrees Celsius to 120 degrees Celsius is formed during the air-cooled hot die face pelletizing of granules.

13. The apparatus of claim 10, wherein the process gas temperature control and process gas dosing device regulates the quantity of process gas, temperature and speed in such a way that a crystal nucleation temperature in a temperature range between 100 degrees Celsius to 120 degrees Celsius is formed during the air-cooled hot die face pelletizing of granules for the purpose of forming crystallization nuclei of poly-ethanediol terephthalate granules cut from the surface.

14. The apparatus of claim 10, wherein the roller plate projects into the centripetal process gas flow at an acute angle from 5 degrees to 15 degrees.
